(19) United States
(12) Patent Application Publication
(10) Pub. No.: US 2004/0160877 A1
(43) Pub. Date: Aug. 19, 2004

(54) Optical disk apparatus and characteristic determining method

(76) Inventors: Takuya Yamamoto, Atsugi-Shi (JP); Masao Fukaya, Atsugi-Shi (JP)

Correspondence Address: LADAS & PARRY, 224 SOUTH MICHIGAN AVENUE, SUITE 1200, CHICAGO, IL, 60604, US

(21) Appl. No.: 10/749,707

(22) Filed: Dec. 31, 2003

(30) Foreign Application Priority Data
Jan. 9, 2003 (JP) 2003-003313

(51) Int. Cl. G11B 7/00

(52) U.S. Cl. 369/53.22; 369/47.39; 369/47.51

(57) ABSTRACT

An optical disk apparatus that is capable of accurately determining a characteristic of an optical disk is disclosed, where the optical disk has recording and/or replaying characteristics that vary under different conditions. Also, a method for determining such characteristic is disclosed. Specifically, the optical disk apparatus, which is adapted to irradiate an optical beam on an optical disk to realize signal recording, replays a signal recorded on the optical disk after a predetermined time period elapses from the time of the recording of the signal, determines a characteristic of the optical disk based on the replayed signal, and controls the signal recording on the optical disk based on the determined characteristic.

### BACKGROUND OF THE INVENTION

1. Field of the Invention

The present invention relates generally to an optical disk apparatus and a characteristic determining method. In particular, the present invention relates to an optical disk apparatus for recording a signal on an optical disk having recording and/or replaying characteristics that vary under different conditions.

2. Description of the Related Art

Optical disks such as the CD-R (compact disk-recordable) and CD-RW (compact disk-rewritable) have different optimal recording laser powers depending on their manufacturers and types, for example. Thus, in an optical disk apparatus for recording signals onto an optical disk such as a CD-R (compact disc-recordable) or a CD-RW (compact disc-rewritable), when a disk is set and a recording instruction is received, an OPC (optimum power control) process is performed in order to determine the optimum recording laser power for the disk. The OPC process is performed using a PCA (power calibration area), which is provided at an inner circumference area of the optical disk.

A description of the OPC process is given below.

In OPC, first, a predetermined signal is recorded on the PCA at a predetermined recording speed while changing the recording laser power to achieve 15 different recording power levels. This process is repeated with different recording speeds.

Then, the signal recorded on the PCA is replayed (reproduced), and a β value is obtained based on a peak value and a bottom value of the replayed signal. This β value is obtained for each of the 15 recording power levels.

A calculation method of the β value is described below.

FIG. 7 is a diagram illustrating the calculation method of the β value.

Given that the peak value and the bottom value of a replayed signal S in FIG. 7 are denoted as A1 and A2, respectively; the β value can be calculated based on formula (1) shown below.

β=(A1+A2)/(A1−A2) (1)

A relation between the β value and the recording power is described below.

FIG. 8 is a diagram illustrating the relation between the recording power and the β value.

The β value changes depending on the recording power as is shown in FIG. 8. The change may vary depending on the manufacturer or the type of optical disk, for example. An optimum recording power pwO may be determined by obtaining the recording power corresponding to a preset optimum β value, βO (this value varying depending on factors such as the manufacturer and type of optical disk).

Specifically, out of the 15 different β values obtained from the replayed signal corresponding to the signal recorded using recording powers of 15 different levels, the β value that is approximately equal to βO is determined and its corresponding recording power is set as the optimum recording power for the predetermined recording speed.

It is noted that the number of recording power levels used in the OPC and the optimum power calculation method are not limited to the above examples.

The above operation is repeated using different recording speeds to obtain the optimum recording power for each of the different recording speeds. The obtained optimum recording powers for the respective recording speeds are set to a register of a microcomputer and are used upon recording a signal.

FIG. 9 is a diagram illustrating a change in the β value with respect to time elapsed after the recording of its corresponding signal.

As is shown in FIG. 9, the β value is relatively large right after the recording and then stabilizes to a predetermined value βO with the elapse of time. In other words, a certain period of time T0 is required after recording before the β value stabilizes to an accurate value.

However, in the conventional optical disk apparatus, the change in the β value after recording is not taken into account. However, the recording power cannot be accurately determined.

### SUMMARY OF THE INVENTION

The present invention has been conceived in response to the above problem of the related art and its object is to provide an optical disk apparatus that is capable of accurately determining a characteristic of an optical disk and a method of determining such characteristic.

An optical disk apparatus of the present invention that is adapted to irradiate an optical beam on an optical disk to realize signal recording realizes the processes of replaying a signal recorded on the optical disk after a predetermined time period elapses from the time of the recording of the signal, determining a characteristic of the optical disk based on the replayed signal, and controlling the signal recording on the optical disk based on the determined characteristic.

According to the present invention, a signal recorded on the optical disk is replayed after a predetermined time period elapses, a characteristic of the optical disk is determined based on the replayed signal, and the signal recording on the optical disk is controlled based on the determined characteristic. Thus, the characteristic may be determined from the signal after the characteristic is stabilized, and an accurate characteristic can be obtained. In this way, signal recording may be performed under optimal conditions.

### BRIEF DESCRIPTION OF THE DRAWINGS

FIG. 1 is a block diagram illustrating an optical disk apparatus according to an embodiment of the present invention;

FIG. 2 is a flowchart illustrating an operation of a microcomputer during a recording operation;

FIG. 3 is a flowchart illustrating an operation of the microcomputer during a WPC process;

FIG. 4 is a diagram illustrating the WPC process;

FIG. 5 is a flowchart illustrating an exemplary variation of the WPC process realized by the microcomputer;

FIG. 6 is a diagram illustrating the WPC process of FIG. 5;

FIG. 7 is a diagram illustrating a process of determining a β value;

FIG. 8 is a diagram illustrating a relation between a recording power and the β value; and

FIG. 9 is a diagram illustrating a change of the value with respect to time elapsed after recording of a signal.

### DETAILED DESCRIPTION OF THE PREFERRED EMBODIMENTS

In the following, principles and embodiments of the present invention will be described with reference to the accompanying drawings.

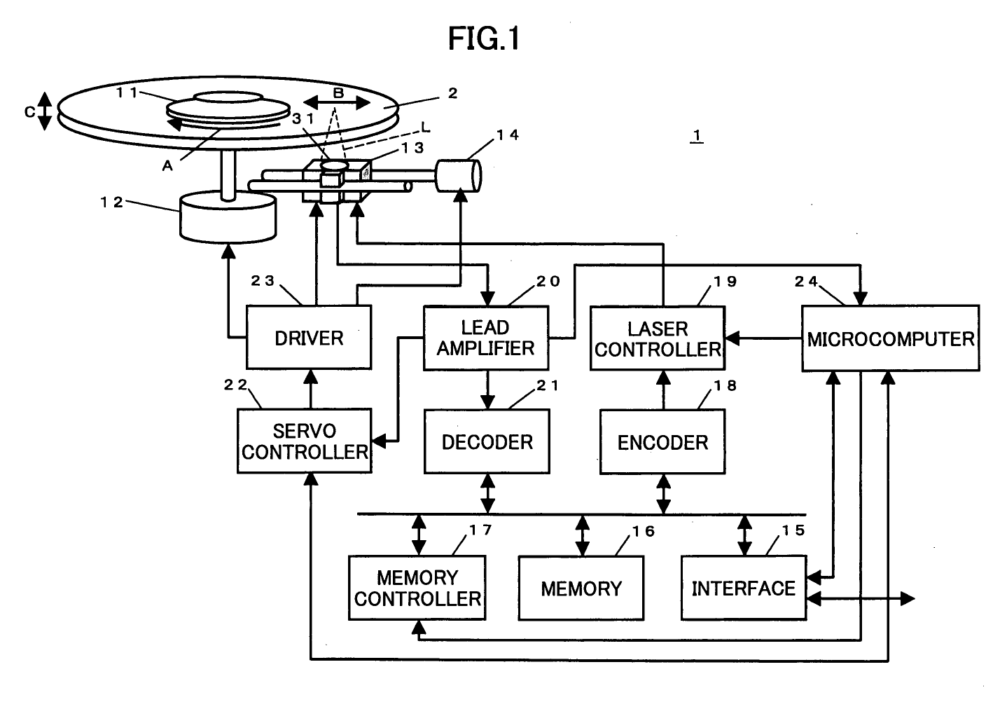

FIG. 1 is a block diagram showing an exemplary configuration of an optical disk apparatus according to an embodiment of the present invention.

An optical disk apparatus 1 of the present embodiment may be a drive apparatus that is capable of recording and/or replaying an optical disk such as a CD-R or a CD-RW, for example, and may include a turntable 11, a spindle motor 12, an optical pickup 13, a sled motor 14, an interface 15, a memory 16, a memory controller 17, an encoder 18, a laser controller 19, a lead amplifier 20, a decoder 21, a servo controller 22, a driver 23, and a microcomputer 24, for example.

An optical disk 2 may be set to the turntable 11. The turntable 11 may be rotated by the spindle motor 12 and the optical disk 2 may be rotated by the turntable 11 in a direction indicated by arrow A of FIG. 1. The spindle motor 12 may rotate according to a drive signal from the driver 23, and the rotation speed of the spindle motor 12 may determine the recording speed of the optical disk apparatus 1.

The optical pickup 13 may be arranged to face the optical disk 2, and may irradiate on the optical disk 2 an optical beam L condensed by an objective lens 31. The optical pickup 13 may have an actuator (not shown) for realizing tracking control by wobbling the objective lens 31 in the directions indicated by arrow B and realizing focus control by wobbling the objective lens 31 in the directions indicated by arrow C. This actuator may be driven by the drive signal from the driver 23, and may be arranged to wobble the objective lens 31 in the directions indicated by the arrows B and C. By wobbling the objective lens 31 in the directions of arrow B, tracking control may be realized. By wobbling the objective lens 31 in the directions of arrow C, focus control may be realized.

The driver 23 may supply a drive signal to the spindle motor 12, the sled motor 14, and the actuator for realizing tracking control and focus control based on a control signal from the servo controller 22. The sled motor 14 may be a motor for moving the optical pickup 13 in radial directions of the optical disk 2, namely, in the directions indicated by arrow B. By moving the optical pickup 13 in the directions of arrow B using the sled motor 14, a seek operation and the tracking control operation may be realized.

The servo controller 22 may generate a control signal for controlling the actuator for realizing tracking and focus control and the sled motor 14 based on a tracking error signal and a focus error signal supplied from the lead amplifier 20, and may supply the generated control signal to the driver 23. Also, the servo controller 22 may control the actuator, the sled motor 14, or the rotation of the spindle motor 12 based on an instruction from the microcomputer 24. For example, the servo controller 22 may control the rotation speed of the spindle motor 12 according to a recording speed designated by the microcomputer 24. Also, the servo controller 22 may turn off the focus and tracking actuator and drive the sled motor 13 to execute a seek operation based on an instruction from the microcomputer 24.

The optical pickup 13 may implement an optical detector (not shown). The optical detector may convert signal components of a focus error signal, a tracking error signal, and a recording signal from light reflected from the optical disk 2 into an electrical signal, and may supply this to the lead amplifier 20. The lead amplifier 20 may amplify the focus error signal and the tracking error signal and supply the resulting signals to the servo controller 22. Also, the lead amplifier 20 may amplify the recording signal and supply the resulting signal to the decoder 21 and microcomputer 24.

The decoder 21 may decode the amplified recording signal from the lead amplifier 20. The data decoded by the decoder 21 may be temporarily stored in the memory 16 by the memory controller 17. The data stored in the memory 16 may be supplied to a host computer via the interface 15 connecting to this host computer. The memory 16 may be a RAM (random access memory), and may be used as a buffer memory. The memory controller 17 may control data communications between the interface 15, the memory 16, the encoder 18, and the decoder 21.

Recording data supplied from the host computer and temporarily stored in the memory 16 via the interface 15 may be supplied to the encoder 18. The encoder 18 may encode the recording data to generate a recording signal. The recording signal encoded at the encoder 18 may then be supplied to the laser controller 19. The laser controller 19 may drive a laser diode (not shown) implemented in the optical pickup 13.

The laser diode may emit an optical beam based on a drive signal from the laser controller 19. The optical beam emitted from the laser diode may be condensed by the objective lens 31 and irradiated on the optical disk 2.

During recording, the laser controller 19 may administer the laser diode implemented in the optical pickup 13 to emit light based on the recording signal from the encoder 18. The laser diode may, for example, increase the intensity of the optical beam when the level of the recording signal from the laser controller 19 is high, and decrease the intensity of the optical beam when the level of the recording signal is low. A pit is formed on the optical disk 2 when the intensity of the light emitted from the laser diode is high. Thus, by controlling the intensity of the light emitted from the laser diode according to the recording signal, pits may be formed on the optical disk 2 in accordance with the recording signal.

During replay, the laser controller 19 may control the laser diode to emit light at an approximately constant intensity level at which a pit will not be formed on the optical disk 2. Also, the laser controller 19 may perform APC (automatic power control). In APC control, light emitted from the laser diode is monitored by the optical detector, and the drive signal for the laser diode is adjusted based on the monitoring result so that the emitted light will be at the desired intensity level.

The light irradiated on the optical disk 2 may be reflected. In this case, the intensity of the reflected light may vary depending on whether a pit is formed on the irradiated spot of the optical disk 2. Thus, by detecting the intensity of the reflected light with the optical detector, a signal corresponding to the pits formed on the optical disk 2 may be detected. Since the pits are formed according to the recording signal, the recording signal may be reproduced based on the detected intensities of the reflected signal.

Also, the laser controller 19 may control the intensity of the light emitted from the laser diode based on an instruction from the microcomputer 24. For example, upon receiving an instruction from the microcomputer 24 to increase the light intensity, the laser controller 19 may raise the level of the drive signal it supplies to the laser diode so that the light intensity of the light emitted by the laser diode may be increased. Also, upon receiving an instruction from the microcomputer 24 to decrease the light intensity, the laser controller 19 may lower the level of the drive signal it supplies to the laser diode so that the light intensity of the light emitted from the laser diode may be decreased.

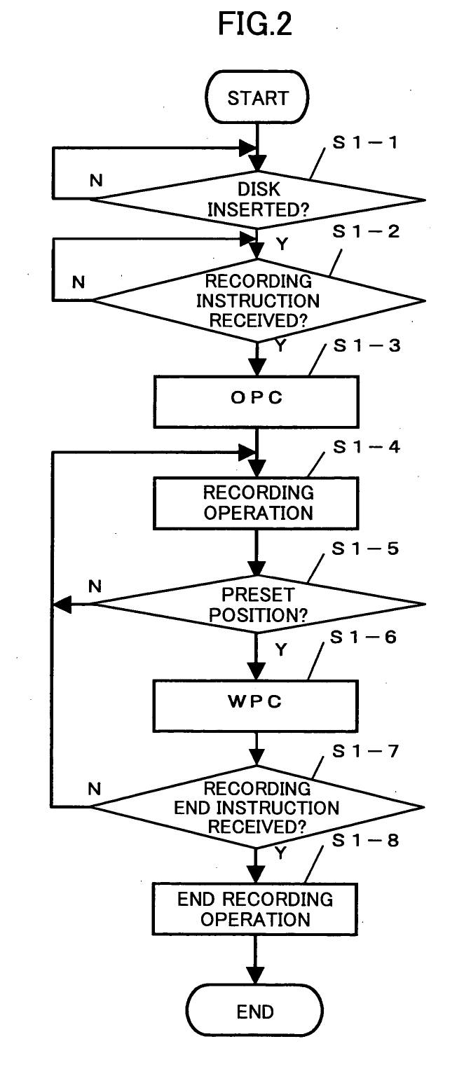

FIG. 2 is a flowchart illustrating an operation of the microcomputer 24 during recording.

When the optical disk 2 is inserted in step S1-1 and signal recording on the inserted optical disk 2 is instructed in step S1-2, the microcomputer 24 executes OPC (optimum power control) in step S1-3. The OPC is realized using a PCA (power calibration area) implemented at the inner circumference area of the optical disk 2.

In OPC, a predetermined signal is recorded on the PCA at a predetermined recording speed while changing the recording laser power to achieve 15 different recording power levels. Then, the signal recorded on the PCA is replayed and the β value corresponding to each of the 15 different recording power levels is calculated from the peak value and the bottom value of the corresponding replay signal using formula (1), and the recording power corresponding to βO is obtained through approximation. This recording power is set as the optimum recording power for the predetermined recording speed. Then, the obtained optimum recording power is set to a register implemented in the microcomputer 24. The above process is repeated with different recording speeds to obtain the optimum recording powers of the respective recording speeds, and the obtained optimum recording powers are set to the register implemented in the microcomputer 24. In this way, the OPC process of the microcomputer is completed. It is noted that the number of recording power levels and the optimum recording power calculation method are not limited to the above examples.

Next, in step S1-4, the microcomputer 24 starts a recording operation. The microcomputer 24 performs the recording operation using the optimum recording power obtained in the OPC process of step S1-3 corresponding to the recording speed being used. When the recording position reaches a preset position in step S1-5, the microcomputer 24 starts a WPC (write power compensation) process in step S1-6.

The WPC process corresponds to a process of obtaining the β value at a preset position during a recording operation and compensating for the recording power based on the obtained β value. For example, the β value characteristics at the inner circumference and outer circumference of the optical disk 2 may vary and thus, optimum recording may not be realized at the outer circumference of the optimum disk 2 with the optimum recording power obtained in the OPC. Thereby, the WPC process may be performed in order to correct the optimum recording power at the preset position.

The microcomputer 24 repeats the process steps S1-4 through S1-6 until it receives a recording end instruction in step S1-7. When the ending instruction is received in step S1-7, the recording operation is ended in step S1-8.

In the following, a detailed description of the WPC process is given.

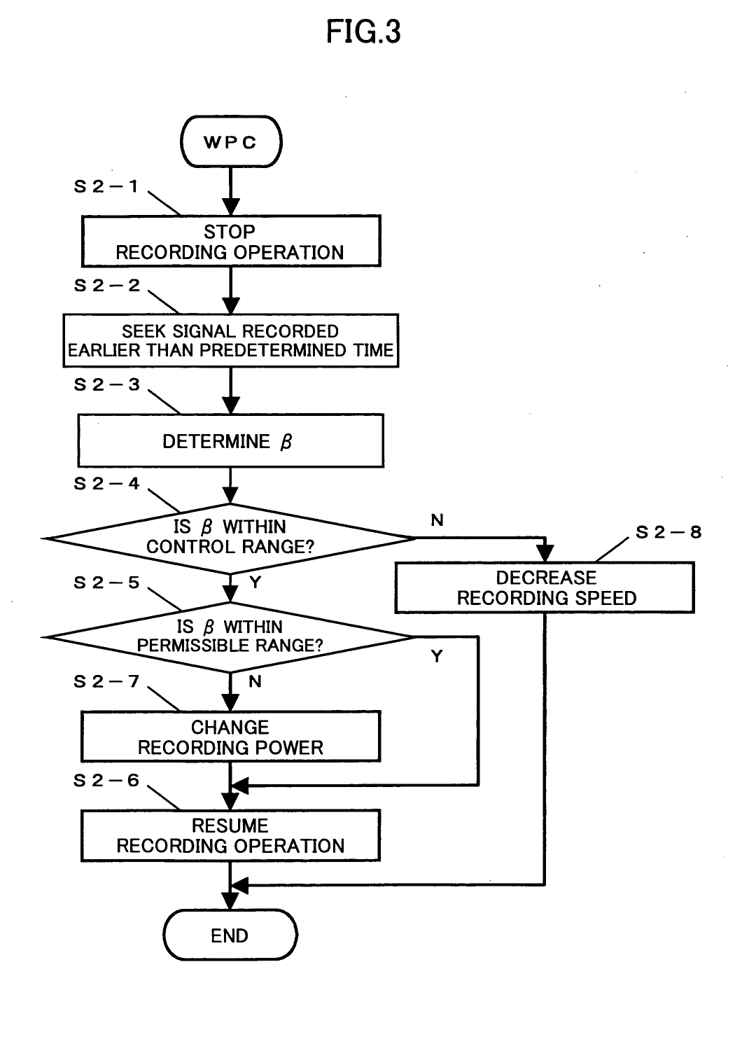

FIG. 3 is a flowchart illustrating an operation of the microcomputer 24 during the WPC process.

First, when the WPC process is started, the microcomputer 24 stops the recording operation in step S2-1. Then, in step S2-2, the microcomputer 24 seeks a recorded signal that has been recorded prior to a predetermined time.

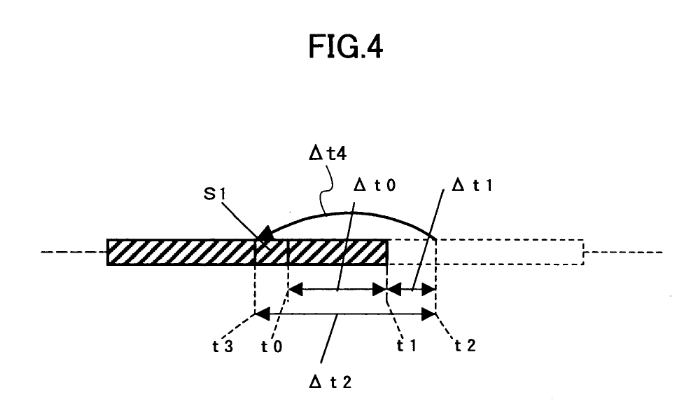

FIG. 4 is a diagram illustrating the operation of the WPC process.

In FIG. 4, the WPC process is started and the recording operation is stopped at time t1, and at time t2, after an operation waiting time Δ t1 has elapsed from time t1, a recorded signal S1 recorded at time point t3, which is prior to time point t2 by time period Δ t2, is sought, and the recorded signal S1 is read out. The recorded signal S1 corresponds to a signal recorded before time point t0, which is prior to time point t1 by time period Δ t0. In this way, the signal S1 may be read out after a predetermined time period T=(Δ t0+Δ t1) has elapsed from the time of its recording. By setting the predetermined time period T to be approximately 4 seconds, compatibility with most optical disks can be realized. However, the predetermined time period T is not limited to 4 seconds; moreover, the predetermined time period T may, for example, be set to the minimum time period required for the characteristic of signal S1, namely, the β value, to stabilize so as to obtain an accurate β value of the signal S1.

Also, the predetermined time period T may vary depending on the manufacturer of the optical disk.

In step S2-3, the microcomputer 24 obtains a peak value A1 and a bottom value A2 of the signal S1 recorded earlier than the predetermined time period T to calculate its β value. By obtaining the β value of the signal S1 that has been recorded earlier than the predetermined time period T, a stabilized characteristic, namely, an accurate and stabilized β value of the recorded signal S1 may be obtained. Thereby, a suitable recording power may be accurately determined.

Herein, by setting the recording time Δ t0, the operation waiting time Δ t1, and a seek time Δ t4 to their respective minimum required time periods, the WPC process may be realized in a short period of time.

Referring back to FIG. 3, in step S2-4, the microcomputer 24 determines whether the obtained β value is within a control range corresponding to a permissible range for controlling the recording through recording power control.

If it is determined in step S2-4 that the β value is within the control range, the microcomputer 24 then determines in step S2-5 whether the β value is within a permissible range for the current recording power.

If it is determined in step S2-5 that the β value is within the permissible range, the recording operation is resumed in step S2-6 without changing the recording power. On the other hand, if is determined in step S2-5 that the β value is outside the permissible range, the microcomputer 24 changes the optimum recording power in step S2-7 so that the β value may be reduced and then restarts the recording operation in step S2-6.

If it is determined in step S2-4 that the β value is outside the control range, the recording cannot be adequately compensated for by merely changing the recording power. Thus, in step S2-8, the microcomputer 24 decreases the recording speed by one step, sets the optimum recording power for the decreased recording speed as the recording power to be used, and ends the WPC process. For example, if the original recording speed is 40×, this may be lowered to 38×; if the original recording speed is 24×, this may be lowered to 22×.

As can be appreciated from the above descriptions, according to the present embodiment, a signal may be recorded with the optimal recording power during a recording operation.

It is noted that in the present embodiment, the recording power is controlled through replaying a signal that has been recorded earlier than the predetermined time period T to obtain a stabilized β value. However, in another embodiment, the latest signal may be replayed after waiting for a predetermined time period to obtain its β value.

FIG. 5 is a flowchart illustrating an exemplary variation of the WPC process performed by the microcomputer 24. In this flowchart, process steps that are identical to those of FIG. 3 are given the same numerical references and their descriptions are omitted.

According to the present embodiment, the microcomputer 24 stops the recording operation in step S2-1, activates a timer in step S3-1, and waits until a predetermined time period elapses in step S3-2. Then, after the predetermined time period has elapsed, the microcomputer 24 seeks the latest recorded signal and reads the peak value and the bottom value of the latest recorded signal in step S3-3, and determines its β value in step S2-3.

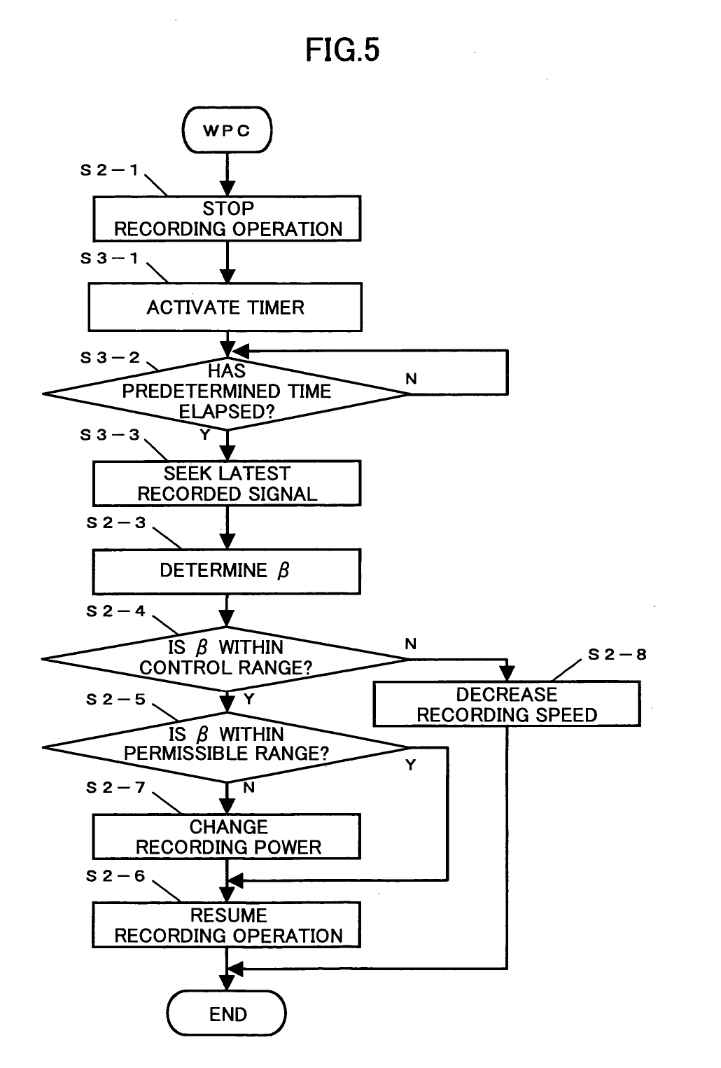

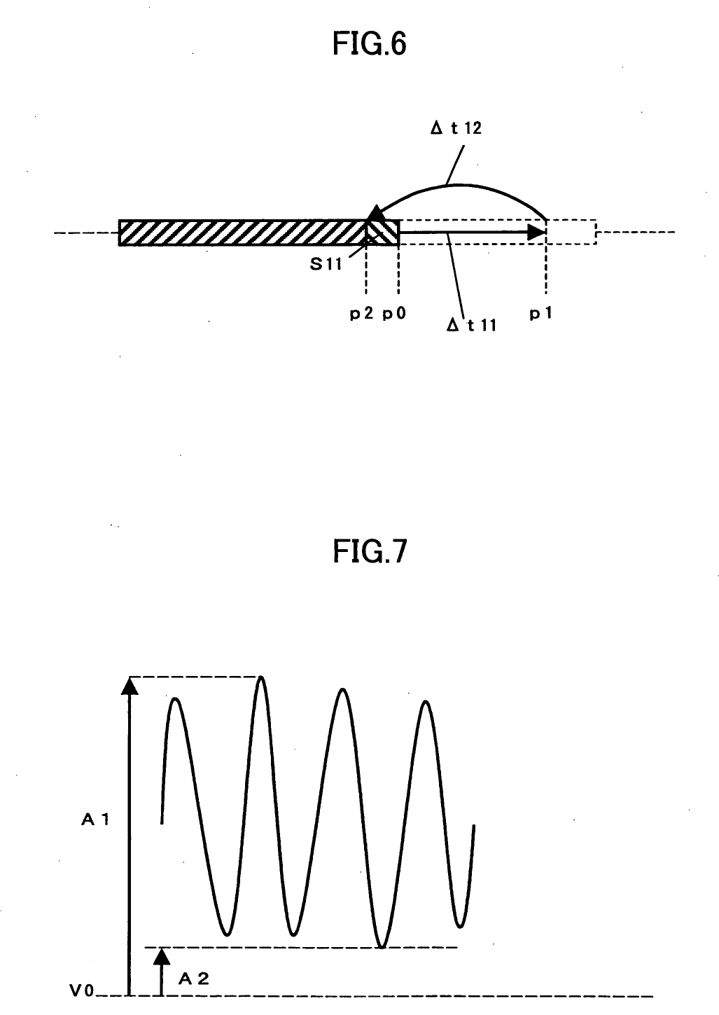

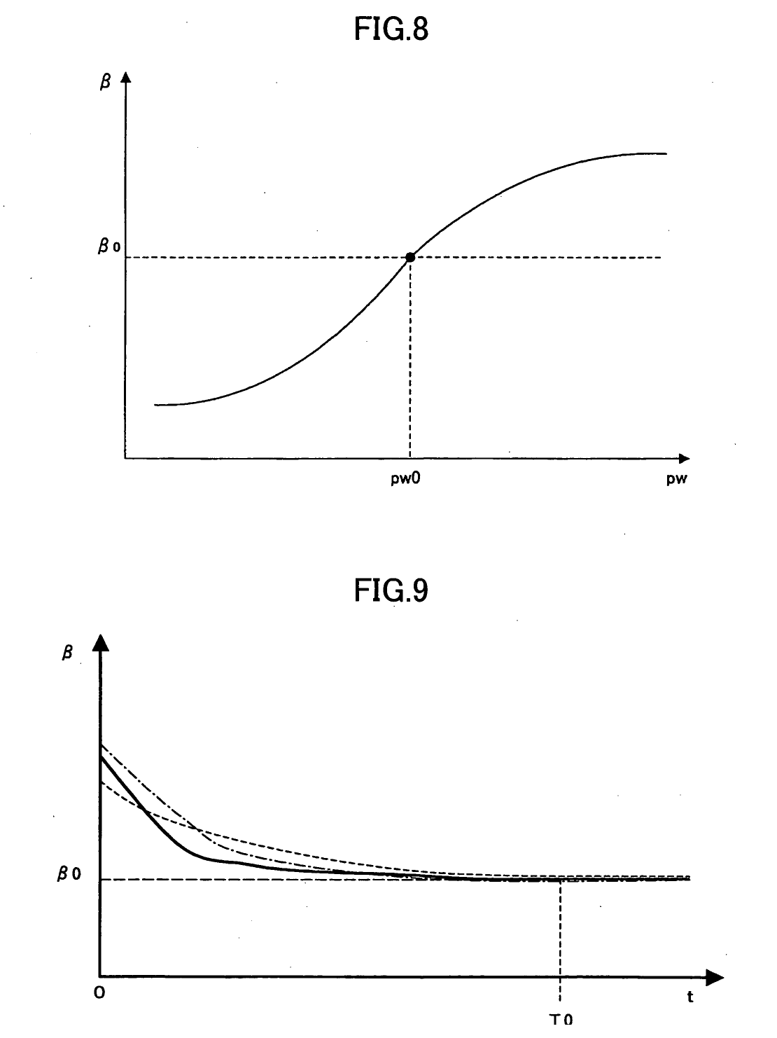

FIG. 6 is a diagram illustrating the operation of the WPC process according to the present variation embodiment.

The recording operation is stopped at position p0, and at position p1 after time period Δ t11 elapses from position p0, a position p2 of the latest signal S11 is sought in order to read the latest signal S11 and obtain its β value from its peak value and bottom value.

In this embodiment, by setting the time Δ t11 with due consideration to a seek time Δ t12 for seeking the position p2 from position p1, the latest signal may be read in a minimum time period.

It is noted that in the above descriptions, an optical disk apparatus for recording a signal on a CD-R (compact disk-recordable) or a CD-RW (compact disk-rewritable) has been given as an illustrative embodiment. However, the present invention is not limited to this embodiment, and may be applicable to other optical apparatuses that are capable of recording on optical disks such as a DVD-RAM and a MO (magneto-optical disk), for example.

Also, the characteristic determination method of the present invention may be implemented in any recording scheme and is not limited to implementation in a certain recording scheme such as CLV, CAV, and zone CLV.

The present application is based on Japanese Patent No.2003-003313 filed on Jan. 9, 2003, the entire contents of which are hereby incorporated by reference.

What is claimed is:

1. An optical disk apparatus that is adapted to irradiate an optical beam on an optical disk to realize signal recording, said optical disk apparatus comprising:
characteristic determining means for replaying a signal recorded on the optical disk after a predetermined time period elapses from the time of the recording of the signal, and determining a characteristic of the optical disk based on the replayed signal; and
control means for controlling the signal recording on the optical disk based on the characteristic determined by the characteristic determining means.

2. The optical disk apparatus as claimed in claim 1, wherein the characteristic determining means is arranged to replay the signal recorded on the optical disk after a time period required for the characteristic of the optical disk to stabilize elapses.

3. The optical disk apparatus as claimed in claim 1, wherein the characteristic determining means is arranged to replay the signal that is recorded earlier in time by the predetermined time period.

4. The optical disk apparatus as claimed in claim 1, wherein the control means controls a power of the optical beam irradiated on the optical disk based on the characteristic determined by the characteristic determining means.

5. The optical disk apparatus as claimed in claim 1, wherein the control means controls a recording speed for the signal recording based on the characteristic determined by the characteristic determining means.

6. A characteristic determining method for an optical disk apparatus that is adapted to irradiate an optical beam on an optical disk to realize signal recording, said method comprising:
replaying a signal recorded on the optical disk after a predetermined time period elapses from the time of the recording of the signal; and
determining a characteristic of the optical disk based on the replayed signal.

7. The characteristic determining method as claimed in claim 6, wherein the signal is replayed after a time period required for the characteristic of the optical disk to stabilize elapses.

8. The characteristic determining method as claimed in claim 6, wherein the signal to be replayed is recorded earlier in time by the predetermined time period.

9. An optical disk apparatus that is adapted to irradiate an optical beam on an optical disk to realize signal recording, said optical disk apparatus comprising:
a microcomputer adapted to record a signal on the optical disk, wait a predetermined time period to elapse from the time of the recording of the signal to allow a characteristic of the signal to stabilize, and replay the signal and determine the characteristic of the signal based on the replayed signal.

10. A method of determining a characteristic of a recording signal on an optical disk, comprising:
recording a signal on the optical disk;
waiting a predetermined time period to elapse from the time of the recording of the signal to allow a characteristic of the signal to stabilize; and
replaying the signal and determining the characteristic of the signal based on the replayed signal.

11. A method of controlling recording of a signal on an optical disk, comprising:
performing a recording operation on the optical disk;
stopping the recording operation, and allowing a predetermined time period to elapse for a characteristic of a signal recorded during the recording operation to stabilize;
replaying the signal and determining the characteristic of the signal based on the replayed signal; and
restarting recording based on the characteristic of the signal.

12. The method as claimed in claim 11, wherein if the characteristic of the signal is within a predetermined control range but outside a permissible range for a current recording power, then further including the step of changing the recording power to thereby reduce the characteristic of the signal before restarting the recording.

13. The method as claimed in claim 11, wherein if the characteristic of the signal is outside a predetermined control range, then further including the step of decreasing a recording speed and changing the recording power according to the decreased recording speed.

14. The method as claimed in claim 11, wherein the recording operation includes recording a plurality of signals, and the step of replaying the signal includes replaying the latest signal of the recording operation.

15. The method as claimed in claim 11, wherein the recording operation includes recording a plurality of signals, and the predetermined time period is measured from the latest signal of the recording operation.
